(19) United States
(12) Patent Application Publication
(10) Pub. No.: US 2003/0108725 A1
(43) Pub. Date: Jun. 12, 2003

(54) Visual images produced by surface patterning

(76) Inventors: Matthew Hamilton, Philadelphia, PA (US); Walters Russel, Philadelphia, PA (US); Kinnier Alex, Doylestown, PA (US)

Correspondence Address: MATHEWS, COLLINS, SHEPHERD & MCKAY, P.A., 100 THANET CIRCLE, SUITE 306, PRINCETON, NJ, 08540-3674, US

(21) Appl. No.: 10/199,804

(22) Filed: Jul. 19, 2002

Related U.S. Application Data
(60) Provisional application No. 60/337,724, filed on Dec. 10, 2001.

(51) Int. Cl. B05D 5/12

(52) U.S. Cl. 428/195.1; 428/426; 427/118

(57) ABSTRACT

It is an object of the present invention to provide novel signs and visual displays produced by different behavior of liquids applied to hydrophilic and hydrophobic surfaces on patterned surfaces. It is also an object of the present invention to provide articles baring logos and alphanumeric text produced by application of liquids to patterned material surfaces. There is further provided a method for producing novel signs and visual displays by producing patterned hydrophobic and hydrophilic surfaces. Also provided are processes for producing patterned surfaces.

### CROSS-REFERENCE TO PRIOR APPLICATIONS

This application claims the benefit of the following provisional application: U.S. Ser. No. 60/337,724 filed Dec. 12, 2001.

### SUMMARY OF THE INVENTION

It is an object of the present invention to provide novel signs and visual displays produced by different behavior of liquids applied to hydrophilic and hydrophobic regions of patterned material surfaces. It is also an object of the present invention to provide articles bearing logos and alphanumeric text produced by application of liquids to patterned material surfaces. There is further provided a method for producing novel signs and visual displays by producing patterned hydrophobic and hydrophilic surfaces. Also provided are processes for producing patterned surfaces.

### BACKGROUND OF THE INVENTION

Condensation images or “breadth figures” are images of regions of different wetability or hydrophobicity when humid air is exposed to a cold surface. Self-assembled monolayers (SAMs) are highly ordered small molecules that form strong chemical bonds to a surface providing a stable coating. The formation of breath figures was originally used as a method for detecting contamination on surfaces Subsequently López et al. were able to visualize surface patterns with dimensions greater ≧˜10 μm on gold surfaces with thiol derivatives. (Gabreil P. López et al. Science 1993 260:647-49)

When a liquid is placed on a surface, the bulk structure of the liquid depends on the chemical properties of the liquid and the surface. Generally a liquid will not wet a surface and spread out into a thin film, but instead it will form a droplet with a definite angle between the droplet and the surface, the contact angle. The contact angle that a liquid forms on a given surface can be determined through Young's Equations and knowledge of the surface energy between the surface and the liquid, the surface and the air, and between the liquid and the air.

The surface energy is, in part, dependent on the hydrophilicity/hydrophobicity of the surface and the liquid. If there is a hydrophobicity mismatch (i.e. an unfavorable interaction) between the surface and the liquid, e.g. a hydrophilic liquid (water) on a hydrophobic surface (Teflon®), the liquid will form droplets on the surface with a large contact angle. Conversely if the hydrophobicity of the liquid and the surface are similar (i.e., a favorable interaction) the same hydrophilic liquid on a hydrophilic surface (glass) will wet the surface and form a thin film with a contact angle approaching zero. The larger the disparity between the hydrophilicity/hydrophobicity of the liquid and the surface, the larger the resulting visual contrast between the respective regions. Hydrophilic/hydrophobic patterns can also be used to vary the thickness of liquid films in predefined regions of a patterned surface even though the contact angle is very small. As shown in FIG. 1, the hydrophilic liquid 2 and 5 is constrained from wetting a region with unfavorable interactions 1. On a hydrophilic portion of the surface, 3, the liquid initially from a thin film until the hydrophilic surface is completely covered. Additionally water applied to that region results in an increase in the thickness of the liquid In contrast liquid 7 on the hydrophobic surface forms droplets which do not wet the surface and remain localized to limit the unfavorable interaction with the surface. Several stages in the formation of liquid droplets on patterned surfaces have been identified. Initially small droplets nucleate uniformly across which grow with coalescing. Subsequently the droplets grow and coalesce with altering their distribution on the surface. Round drops combine with adjacent drops to from elongated drops. Subsequently new droplets nucleate between older and larger droplets of varying shape (López, supra) Hydrophilic and hydrophobic surfaces have been used to impart desired properties to glass surfaces as outline below.

U.S. Pat. Nos. 3,310,429 and 3,352,429 (K. Gunnar and R S Hansen) have disclosed hydrophobic coatings useful for rendering glass surface water repellant and preventing the accumulation of water on surfaces such as airplane windshields These coatings were produced with quaternary ammonium salts with long hydrocarbon chains linked to the surface by ionic interactions.

U.S. Pat. No. 6,340,502 B1 (Azzopardi et al.) have disclosed a composition for a hydrophobic coating containing at least one trialkoxysilane and at least one trihalosilane each having a perfluorinated group on at least one end of the molecule and a method for forming a monolithic, laminated or multiple glazed coating of this type on a substrate. The coating forms a nonmetal surface useful in the aeronautical, railway or automotive fields or in buildings or household fittings for example decorative panels, furniture and household electrical appliances. Treatment of the surface reduces the unattractive appearance resulting from the accumulation of water and/or dirt.

U.S. Pat. No. 6,352,758 (Huang et al) described articles with anti-dew surface patterns containing alternating hydrophobic and hydrophilic surface regions. The hydrophobic regions are sufficiently narrow that under dew conditions moisture accumulated on the hydrophobic region migrates to the hydrophilic region thus preventing the accumulation of water droplets. In frost conditions the hydrophobic region remains relatively frost-free maintaining at least partial transparency of the surface. The coatings were adapted to glass surfaces in greenhouses or indoor pools and were increased the visibility of traffic signs that employ retroflective sheeting. Huang described a process wherein inorganic oxide particles are selectively applied to portions of a surface covered with a mask limits coverage to specific regions of the surface. The surface is then exposed to a treatment that removes the polymer to produce hydrophilic regions with high concentrations of inorganic oxide particles and hydrophobic regions with low concentrations of inorganic oxide particles.

European Patent Application 0 620 255 and U.S. Pat. No. 5,270,070 disclose anti-fogging coatings that can be imparted to glass or surface activated plastic substrates by reacting the substrate surfaces with silanol or siloxane-functionalized polymers or fluoropolymers.

U.S. Pat. No. 6,013,372 (M. Hayakawa et al.) describes methods to chemisorb water onto surface to produce superhydrophilic surfaces which can be applied to provide anti-fogging properties or to enhance the wettability of exterior surfaces and enhance self-cleaning when the surface is exposed to rain.

Methods for coating, printing and etching surfaces are well known and these techniques can be adapted to creating signs, logos, patterns and visual displays on material surfaces. Screen printing (A. J. Taggi and P. Walker, Encyclopedia of Chemical Technology, vol. 20, Wiley & Sons, N.Y., N.Y. 1996, p. 105; W Appleton, Screen Printing. A Literature Review, Pira International, Leatherhead, Surrey, U.K. 1984) and stamp-pad printing (R. W. Bassemir et al.Encyclopedia of Chemical Technology, col. 14, Wiley & Sons, N.Y., N.Y. 1996, p. 499) are well known techniques for printing on surfaces.

U.S. Pat. No. 5,512,131 (A. Kumar and G. M. Whitsides) discloses a convenient, inexpensive and reproducible method for patterning a material surface employing an elastomeric stamp having a stamping surface coated with a self-assembling monolayer forming molecular species having a functional group selected to bind to a particular material and contacting the material surface and the elastomeric stamp to transfer the molecular species to the material surface. A plurality of stamping steps can be used to produce a variety of patterns on a material surface and plurality of molecular species with different properties can be deposited on the surface. Portions of the surface not covered by SAM's may subsequently be etched or plated. The process provides a method for incorporating micron and submicron scale patterns into chemical microreactors, biosensors and electronic microcircuitry. A variety of chemical functionality to attach to surfaces applicable to the manufacture of patterned surfaces with signs, logos and visual displays is also described (Y. Xia and G. M. Whitesides, Angew. Chem. Int. Ed. Eng 1998, 37:550-75). U.S. Pat. No. 6,180,239 B1 (G. M. Whitesides et al.) provides an improved method for forming patterned self-assembled monolayers on a surface by deforming the elastomeric stamp during the printing process or by applying a second immiscible liquid to control reactive spreading on the reactive molecular species.

One skilled in the art will recognize a variety of techniques, e.g. ink-jet printing which could be adapted to producing hydrophilicity/hydrophobicity patterns on material surfaces. The references are all incorporated herein by reference in their entirety.

Surprisingly the differences in droplet size, shape, density or contact angle of a liquid on a patterned surface have now been found to be useful to create signs, logos, patterns or visual displays.

### BRIEF DESCRIPTION OF THE DRAWINGS

Specific embodiments of the invention have been chosen for the purpose of illustration and description but are not intended in any way to restrict the scope of the invention. These embodiments are shown in the accompanying drawings wherein:

FIG. 1 illustrates the formation of liquid droplets on a patterned surface.

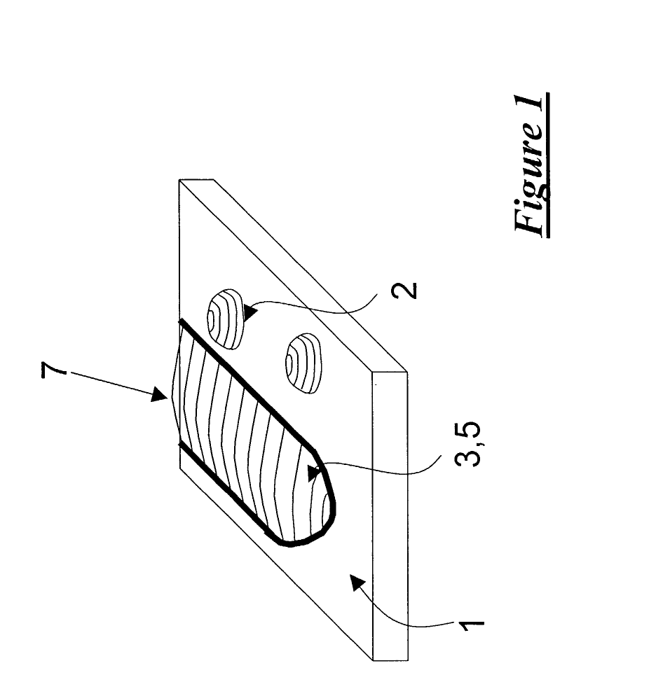

FIG. 2 illustrates a text image formed from surface patterning.

FIG. 3 illustrates a patterned surface prepared by derivatization of an inorganic oxide surface.

FIG. 4 illustrates a sign, logo, pattern of visual display comprised of small regions with channels for improved drainage.

FIG. 5a illustrates positive alphanumeric image and FIG. 5b illustrates a negative alphanumeric image.

FIG. 6 illustrates a signed produce by condensation of moisture from the atmosphere on a cooled glass surface.

FIG. 7 illustrates a visual display produced ultrasonic transducer immerged in a liquid reservoir.

FIG. 8 illustrates a visual display produced an immersion heater and further incorporating a light source for enhanced contrast.

FIG. 9 illustrates a visual display produced centrifugally forced atomization.

FIG. 10 illustrates a visual display produced by a high pressure spray nozzle.

### DETAILED DESCRIPTION OF THE INVENTION

Advertising signs and displays must be visually engaging to attract attention and convey a lasting message. Many types of light and material effects are used to suggest ideas and messages to the viewer. These include carved wood signs, neon lights, but can also include interesting display elements that evoke particular artistic merit. This type of display may be incorporated into larger architectural displays like indoor waterfalls or water fountains and may include etched glass, or particular lighting arrangements that attract viewers and produce moods or stimulate feelings by a viewer. Both signs and display systems, when combined or individually, are important aspects of the design and advertising industry. Promotional materials which incorporate signs, logos, patterns and visual displays are important elements in increasing product awareness among consumers.

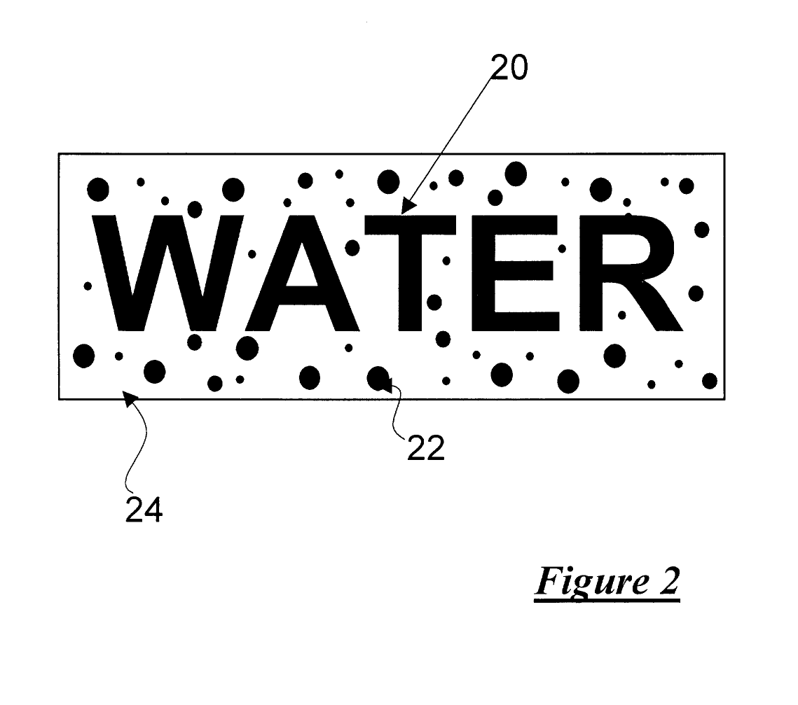

Patterned surfaces have now surprisingly been found to useful for producing new and unique signs, logos, patterns and visual displays. The nature of liquid droplets on a surface depends on the characteristics of the liquid, the surface, and on the liquid-vapor boundary above the surface. The size, shape, coverage and location of the liquid droplets on the surface can be manipulated to produce a visiblesign, logo, pattern or visual display. Varying the pattern of hydrophilic and hydrophobic surfaces produces areas which, when exposed to a liquid, produce distinct areas which convey a message. On a patterned surface the droplets are not randomly distributed; their distribution and location are controlled to create an image. The SAM creating the patterned surface is imperceptibly thin and there is no apparent reason for the pattern. The present invention relates to a display system in which a surface is patterned such that the location of a liquid on the surface can be controlled in order to create a desired sign, logo, pattern or visual display. In FIG. 2 a sign is created from alphanumeric text on a surface. The letters are formed from thin films of water, 20, which form on a hydrophilic region of the surface and are surrounded by small droplets, 22, of water on a hydrophobic region, 24, of the surface.

An embodiment the present invention is an article with a patterned material surface bearing a visually arresting display element that is a useful advertising tool in retail, tradeshows, and restaurants as well as display constructions, architectural elements, novelty devices, advertising signs, or interior design components. Another embodiment of the present invention is unique and arresting architecture elements, interior design components and novelty devices with a patterned material surface.

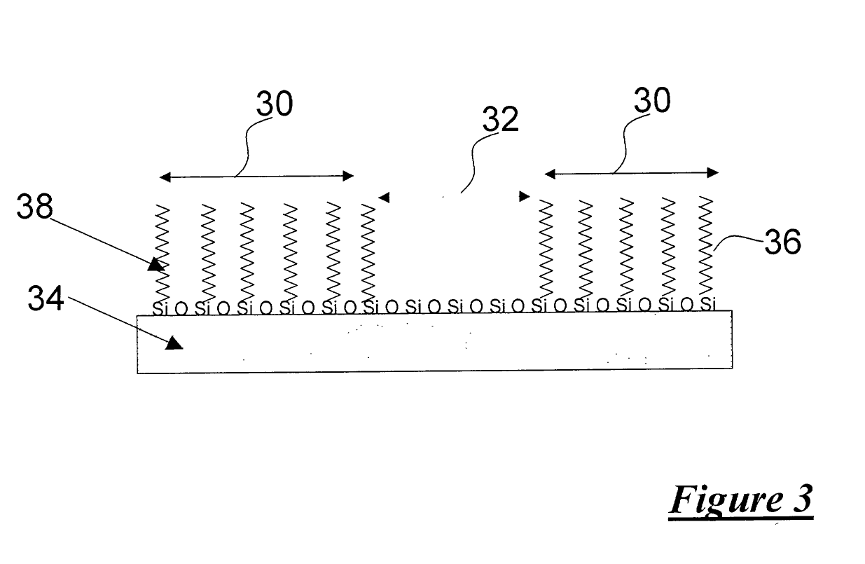

Another embodiment (FIG. 3) of the present invention is a method to create signs, logos, patterns or visual displays by producing surface patterns of hydrophilic, 32, and hydrophobic, 30, surfaces on an inorganic oxide surface, 34, by treating the surface with a molecular species terminated on a first end in a functional group, 38, selected to bind to the surface. The molecular species terminates on a second end with a hydrophobic moiety, 36, capable of forming a self-assembled monolayer (SAM) which modifies the surface properties of the material. Applying a liquid to said patterned surfaces with hydrophobic and hydrophilic regions produce regions with different droplet size, density, polydispersity and structure factor of said liquid drops creating a visibly distinct a sign, logo, pattern or visual display. The patterned surface can be produced on any inorganic oxide surface including, but not limited to glass and aluminum.

Surprisingly in another embodiment of the present invention patterned surfaces can also be produced on polymer surfaces. Polymers typically have a hydrophobic surface unlike the hydrophilic surfaces created by inorganic oxides. Plastics can be fabricated into a vast array of shapes and sizes for many applications. Exposing selected portions of surfaces to an oxidizing species capable of reacting with the exposed plastic surface and creating a hydrophilic surface. Examples of synthetic polymers include elastically deformable polymers which may be thermosetting or thermoplastic including, but not limited to polypropylene, polyethylene, polyvinyl chloride, polyethylene terephthalate, polyurethane, rubbers such as polyisoprene, polybutadiene or latex, polytetrafluoroethylene, polysulfone and polyethylenesulfone polymers or copolymers. Printing on plastic surfaces can be accomplished by the same techniques used for inorganic oxide surfaces.

The surface pattern can be achieved in a number of ways. In FIG. 3, a SAM is employed to create the Pattern Surface. A SAM is a small molecule with one end that chemically binds to the substrate 38 and a second end that is presented to the liquid. In this case we are employing a hydrophobic SAM that has a long hydrocarbon tail 36 that is presented to the fluid. Examples of molecules capable of creating surface patterns include, but are not limited to the following: methyltrichlorosilane, methyltribromosilane, methyltrimethoxysilane, methyltriethoxysilane, methyltriisopropoxysilane,methyltri-t-buthoxysilane; ethyltrichlorosilane, ethyltribromosilane, ethyltrimethoxysilane, ethyltriethoxysilane, ethyltriisopropoxysilane, ethyltri-t-buthoxysilane; n-propyltrichlorosilane, n-propyltribromosilane, n-propyltrimethoxysilane, n-propyltriethoxysilane, n-propyltriisopropoxysilane, n-propyltri-t-buthoxysilane; n-hexyltrichlorosilane, n-hexyltribromosi lane, n-hexyltri methoxysi lane, n-hexyltriethoxysilane, heptadecafluoro-1,1,2,2-tetradecyl trichlorosilane, tridecafluoro-1,1,2,2-tetrahydrooctyl trichlorosilane, heptadecylfluoro-1,1,2,2-tetrahydrodecyl triethoxysilane n-hexyltriisopropoxysilane, n-hexyltri-t-buthoxysilane; n-decyltrichlorosilane, n-decyltribromosilane, n-decyltrimethoxysilane, n-decyltriethoxysilane, n-decyltriisopropoxysilane, n-decyltri-t-buthoxysilane; n-octadecyltrichlorosilane, n-octadecyltribromosilane, n-octadecyltrimethoxysilane, n-octadecyltriethoxysilane, n-octadecyltriisopropoxysilane, n-octadecyltri-t-buthoxysilane; phenyltrichlorosilane, phenyltribromosilane, phenyltrimethoxysilane, phenyltriethoxysilane, phenyltriisopropoxysilane, phenyltri-t-buthoxysilane; tetrachlorosilane, tetrabromosilane, tetramethoxysilane, tetraethoxysilane, tetrabuthoxysilane, dimethoxydiethoxysilane; dimethyldichlorosilane, dimethyldibromosilane, dimethyldimethoxysilane, dimethyldiethoxysi lane; diphenyldichlorosilane, diphenyldibromosilane, diphenyldimethoxysilane, diphenyldiethoxysilane; phenylmethyldichlorosilane, phenylmethyldibromosilane, phenylmethyldimethoxysilane, phenylmethyldiethoxysilane; trichlorohydrosilane, tribromohydrosilane, trimethoxyhydrosilane, triethoxyhydrosilane, triisopropoxyhydrosilane, tri-t-buthoxyhydrosilane; vinyltrichlorosilane, vinyltribromosilane, vinyltrimethoxysilane, vinyltriethoxysilane, vinyltriisopropoxysilane, vinyltri-t-buthoxysilane; trifluoropropyltrichlorosilane, trifluoropropyltribromosilane, trifluoropropyltrimethoxysilane, trifluoropropyltriethox. silane, trifluoropropyltriisopropoxysilane, trifluoropropyltri-t-buthoxysilane; γ-glycidoxypropylmethyldimethoxysilane, γ-glycidoxypropylmethyldiethoxysilane, γ-glycidoxy-propyltrimethoxysilane, γ-glycidoxypropyltriethoxysilane, γ-glycidoxypropyltriisopropoxysilane, γ-glycidoxy propyltri-t-buthoxysilane; γ-methacryloxypropylmethyl dimethoxysilane, γ-methacryloxypropylmethyldiethoxysilane, γ-methacryloxypropyltrimethoxysilane, γ-methacryloxy-propyltriethoxysilane, γ-methacryloxypropyltriisopropoxy silane, γ-methacryloxypropyltri-t-buthoxysilane; γ-aminopropylmethyldimethoxysilane; γ-aminopropylmethyl diethoxysilane, γ-aminopropyltrimethoxysilane, γ-aminopropyltriethoxysilane, γ-monopropyltriisopropoxy silane, γ-aminopropyltri-t-buthoxysilane; γ-mercaptopropylmethyldimethoxysilane, γ-mercaptopropyl methyldiethoxysilane, γ-mercaptopropyltrimethoxysilane, γ-mercaptopropyltriethoxysilane, γ-mercaptopropyl triisopropoxysilane, γ-mercaptopropyltri-t-buthoxysilane; β-3,4-epoxycyclohexyl)ethyltrimethoxysilane, β-3,4-epoxycyclohexyl)ethyltriethoxysilane. The hydrocarbon chains are optionally fully or partially halogenated. The term “halogen” as used herein refers to fluorine, chlorine, bromine or iodine substituents. One skilled in the art will recognize many of these reagents are bifunctional and have a reactive species capable of bonding to the surface and a second reactive species which can be further chemically modified to alter the chemical and physical properties of the surface.

The chemical modification produces a film which is invisible and the sign, logo, pattern or display appears to arise spontaneously on the surface without cause or explanation. While process conditions can be identified which form a monolayer, the actual thickness varies and does not significantly affect the properties of the material surface and the present invention is not limited to any specific quantity of surface-modifying elements.

Transparent, colored translucent or mirrored surfaces can all be optionally employed in the present invention. Transparent clear glass can be readily adapted to surface patterning because the sign, logo, pattern, or visual display is visible through the glass. Strategically placed lighting can be utilized to produce a variety of effects and enhance the visual effect of the device. The use of bimaterials is also possible and within the scope of the invention. In this case a thin material layer which text, logo or pattern is adhered to a material surface to produce the surface pattern. For example a hydrophobic film can be adhered to a hydrophilic glass surface to produce an article with a surface pattern. Other plastics could be used such as acrylics, polyvinylene, polyethylene, etc.

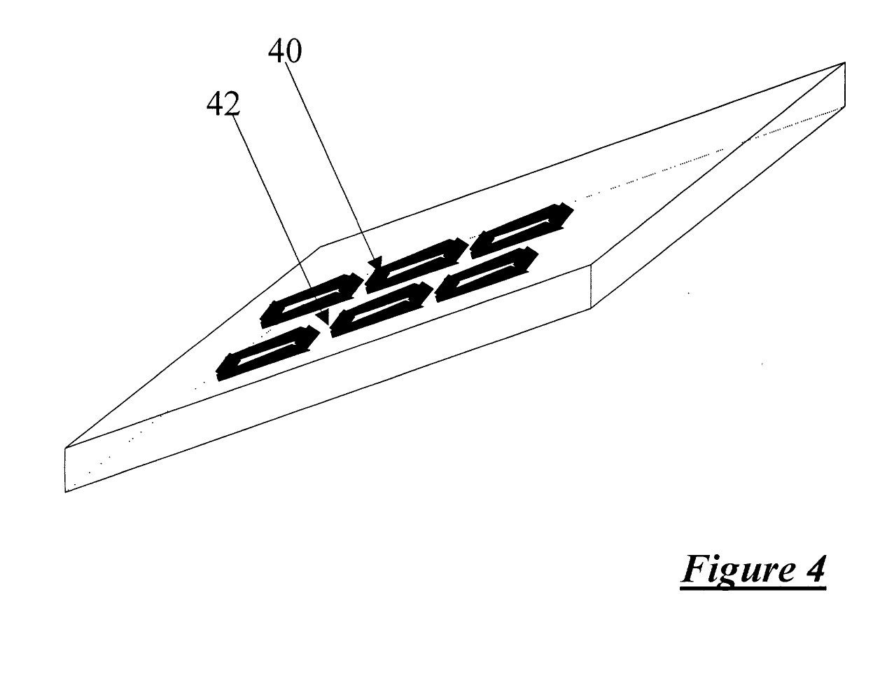

To enhance the text or logo in a large display it can be advantageous in divide the hydrophilic regions into smaller subunits, 40, separated by hydrophobic channels, 42, which act as a barrier and confine the liquid in the hydrophilic regions. (FIG. 4) The size of the droplets and drainage also can be manipulated by placing the patterned surface on an angle.

The liquid can be applied to the patterned surface in a variety of methods to achieve different visual effects. In one embodiment of the inventions there is provided a deluge method, (FIG. 2) wherein a large volume of liquid is sprayed under pressure onto the patterned surface. In this embodiment the liquid continually impinges on the regions of unfavorable interaction 24 and forms droplets 22 that quickly drain off the patterned surface whereas in the regions of favorable interactions 20 the liquid remains and creates a thick perceivable continuous film. An easily visible contrast is established between the blank regions of unfavorable interactions 24 which accumulate relatively little liquid and regions of favorable interactions 20 with a large amount of fluid that fully covers the region.

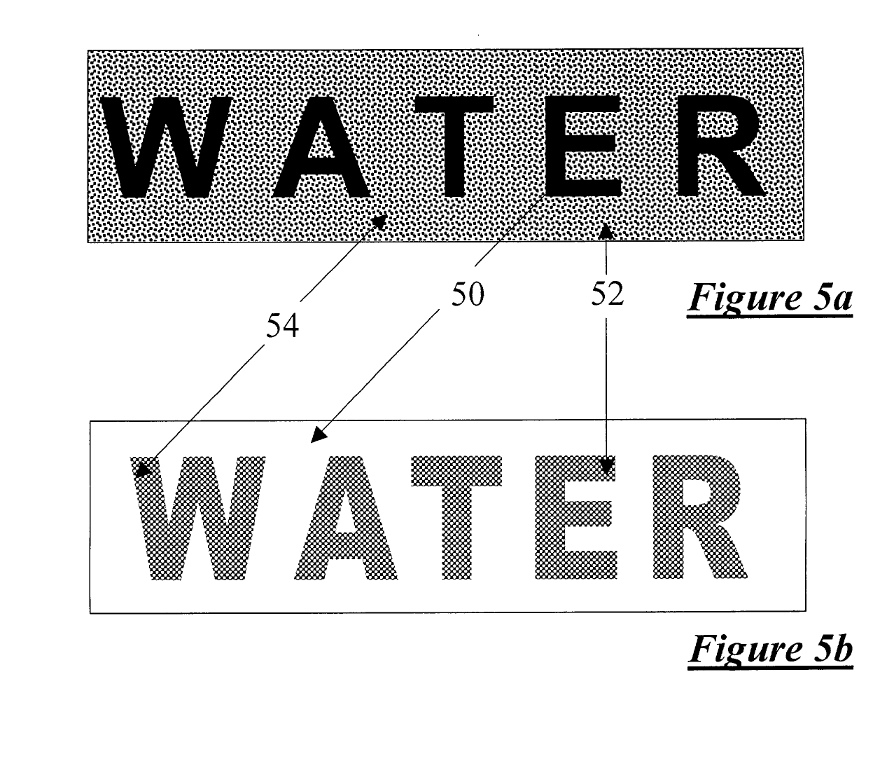

Another embodiment of the present invention is the small droplet method (FIG. 5) where smaller quantities of liquid are applied as a very fine mist or as a condensate with less kinetic energy. The regions of favorable interaction 50 will produce a thin transparent film 52 of fluid, while the regions of unfavorable interaction 54 will accumulate a plurality of small droplets 56 that will diffract light. The effect produces a pointillistic background surrounding the sign, logo, pattern or display which is relatively featureless in the present embodiment. In this embodiment, there all regions of the patterned surface have approximately the same amount of fluid. The contrast is produced by the differences in reflection or refraction of light in different regions rather than the quantity of fluid in the different regions. The image can be created either in the positive or negative fashion. A positive image is form as in (FIG. 5a) wherein the thin film forms the sign, logo, pattern or visual display and the background retains little liquid whereas in a negative image (FIG. 5b) the sign, logo, pattern or visual display are formed in areas with little liquid and the background contains a film of liquid.

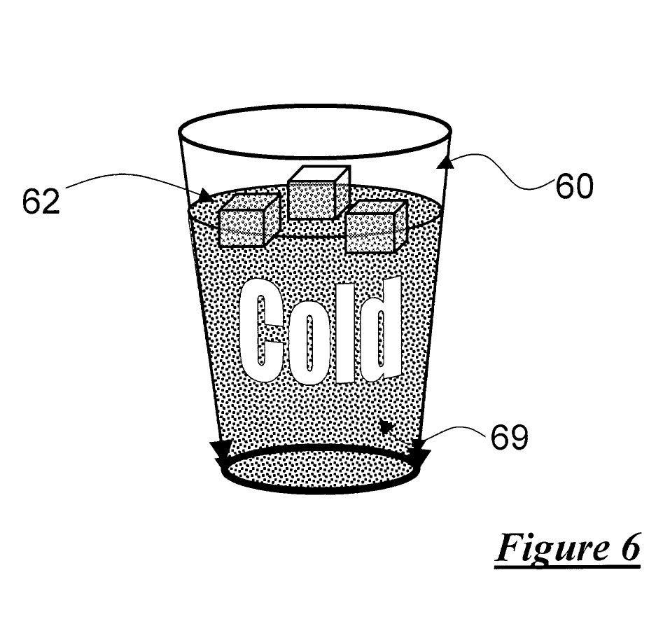

In one embodiment of the present invention the patterned surface is exposed to vapor which condenses on the surface. These embodiments are particularly simple and inexpensive techniques to display an image. In FIG. 6, for example, the patterned surface can be applied to the outside surface of a drink glass 60. , The addition of ice water, cold beverages 60, etc will cause the surface of the glass to cool to a temperature below that of the ambient temperature. The cool surface of the glass will condense water vapor from the surrounding warm, humid air on the surface of the glass. Alternatively a window can condense liquid from warm interior humidified air as typically occurs in colder seasons. In this embodiment a sign, logo, or visual design can displayed without the necessity of a water application apparatus Strategically placed lighting will enhance the visual effect of the device. In this embodiment, in a region of favorable interaction 67 a transparent thin film of fluid will form, and in the regions of unfavorable interaction 69 many small droplets will form and diffract light. The image can be written either in the film of water, as is shown in FIG. 5, or the image can be written in the negative, with the small droplets of fluid.

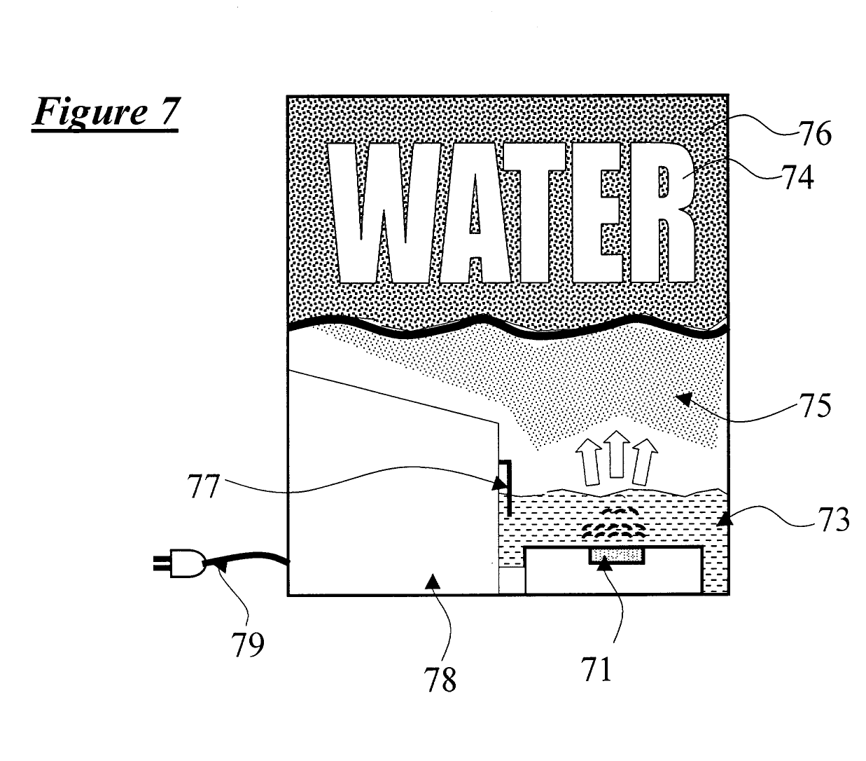

In another embodiment of the present invention the vapor is produced by ultrasonic atomization. (FIG. 7) An ultrasonic atomizing transducer 71 positioned inside a small liquid reservoir 73 generates pockets of high and low pressure within a liquid reservoir. In the low pressure regions localized low temperature boiling occurs increasing the concentration of the liquid in the vapor phase. This embodiment can be utilized to produce a constant amount of water vapor 75 within the environment. Atomization can also be done cyclically as long as water droplets remain on the surface. If the water vapor is contained within a fully or partially closed system the “thick mist” or high water vapor content of the gaseous environment will condense into very fine droplets 76 that adhere to the walls of the container in regions of unfavorable interactions and a thin film 78 in regions of favorable interactions. Control of the air flow within the system is often necessary to insure the entire pattern surface is exposed to the same amount of liquid vapor. If the system is closed the liquid reservoir can be designed to allow unattended operation for long periods of time. In this mode of operation biocidal substances may be added to suppress the growth undesirable microorganisms.

The reservoir is designed to contain a sufficient volume of liquid to cover all walls of the internal compartment with water vapor and provide sufficient additional liquid to provide for efficient operation of the ultrasonic transducer A sensor 77 is provided to shut off the device if the water level drops below a safe level. Additionally a sensor can be used to replenish the reservoir should the liquid level fall below a safe operational level. The structure shown in FIG. 7 is rectangular with the transducer and reservoir in the lower section while the top is all made of transparent materials Ideally the reservoir is positioned so drainage runs into the reservoir. The ultrasonic transducer is powered through an external supply 79. A small fan can be incorporated to cool the ultrasonic device and maintain a homogenous liquid concentration throughout the system. The other support units of the ultrasonic device are contained inside a sealed electronic box 78 in the base of the display.

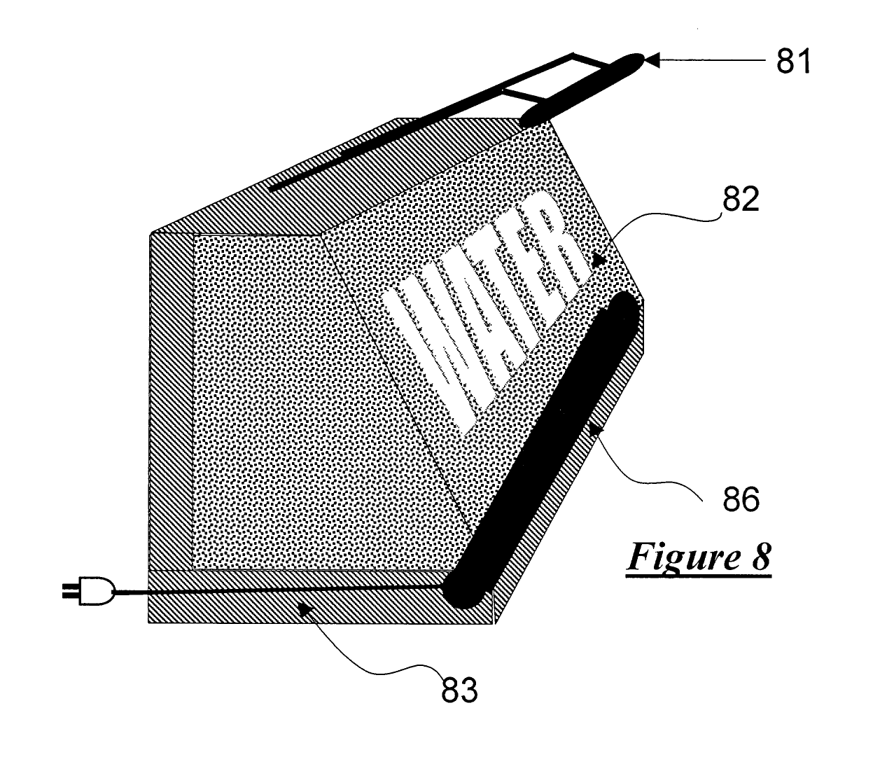

In another embodiment steam atomization is used in humidfy the environment in communication with the patterned surface. (FIG. 8) The term “steam atomization” as used herein means incorporating a thermal element to warm the liquid and increase the concentration of said liquid in the vapor phase. One skilled in the art will appreciate there are a variety of devices which can be used as a source of thermal energy and any such device which humidifies the air in contact with a patterned surface is considered to be within the scope of the present invention. In this embodiment a heating element 86, which can be a heating element or a light source which illuminates the display and provides thermal energy, can be employed to raise the temperature of the water reservoir 83 and the contained vapor. Convective cooling of the surface patterned exterior wall will maintain a temperature differential sufficient to condense droplets 82 on the inside patterned surface. Incorporation of appropriate lightning 81 can enhance the visual effect. Similar misting or atomization of a liquid is achieved through the ultrasonic method. Both ultrasonic and steam atomization techniques can be used in open and closed systems. In an open system provision must be made to replenish the liquid in the reservoir.

Expired air is one source of humidified vapor. In one embodiment of the present invention exhaled air a sign, logo, pattern or visual display is produced. Any patterned surface whose surface temperature is at a sufficiently lower temperature than the vapor contacting said surface can condense liquid onto said surface. In one embodiment the article bearing a surface pattern is a frosted mug or a glass which produces a sign, logo, pattern or visual display as exhaled air is directed towards to the cooled surface of the mug or glass.

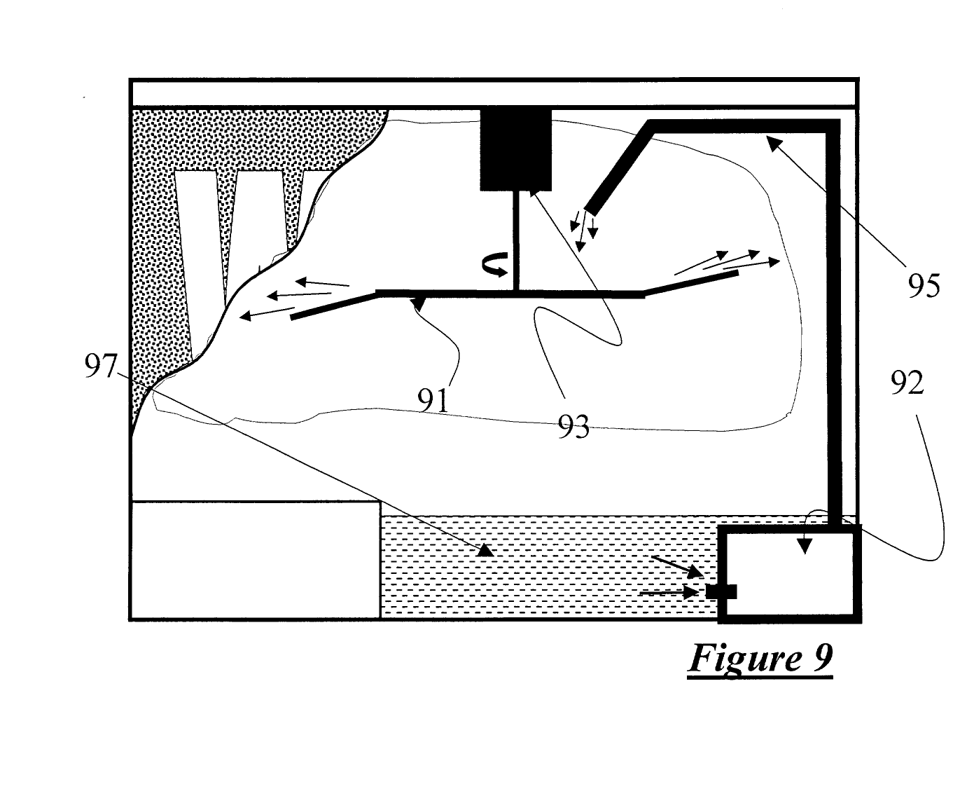

In yet another embodiment of the present invention the liquid droplets are produced centrifugally. (FIG. 9) In this embodiment the water is accelerated to a high angular velocity with a spinning disk 91 which sprays water droplets against the inside of a container that has a glass wall with a patterned surface. The configuration and size of the container can be adapted as required. This spinning disk creates a large angular momentum at the edges which forces water off of the disk and atomizes the water droplets. The bottom section of the structure contains a water pump 92 that pumps water from a reservoir 97 through a conduit 95 to a position above the spinning disk 91. The liquid is allowed to trickle onto the disk where it is sprayed onto the patterned surface. The position of the spinning disk can be varied to create a variety of effects The disk is driven by a motor 93 suspended from the top of the assembly which rotates the disk at sufficient rpm's to create the optimum droplet size for the particular pattern, container and lighting design. The spinning disk produces a steady spray of water to the patterned surfaces. The bottom section is attached to the upper glass structure that both creates a liquid seal with the glass and allows liquid to flow to the bottom structure for recycling. This self-contained system is easily maintained. Variations in the disk size, shape, or RPM alter the droplet size and allow for an optimal contrast between the patterned regions. The sidewall may be constructed of glass, plastic, etc. that is clear, tinted, etched, frosted, etc. and which best fits the design goals of the structure. Lighting can be adapted to enhance the contrast and visual appearance. The design environment, substrate angle, and intended viewer are all necessary considerations to determine the appropriate lighting to maximize reflection and refraction form the patterned surface. These glass sidewalls contain the patterned surface that can be designed to create readable messages or decorative art.

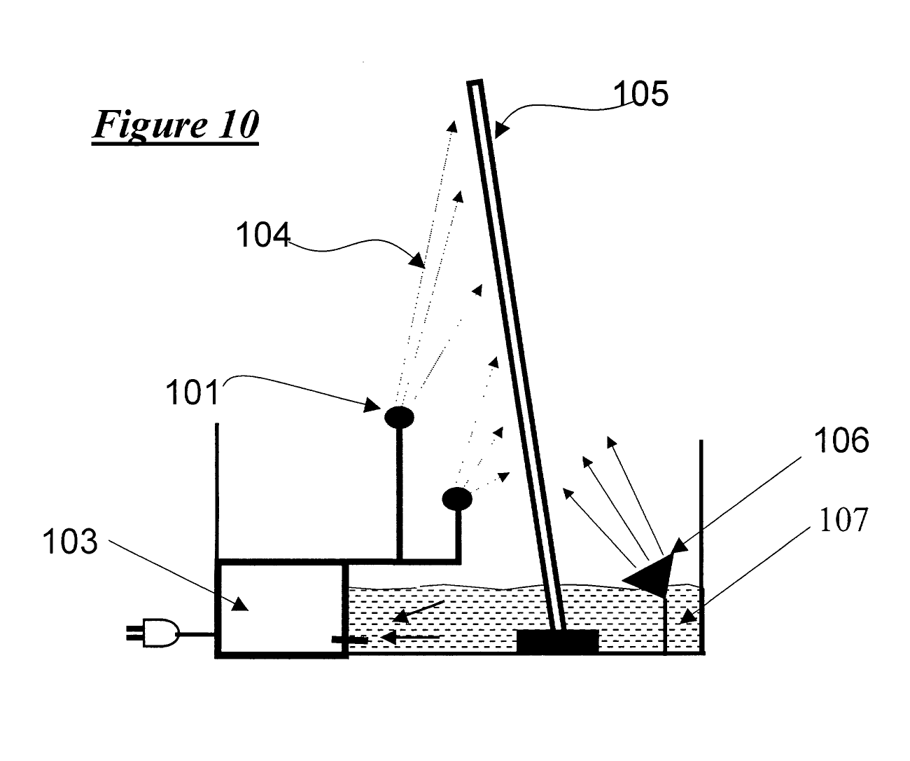

In another embodiment of the present invention (FIG. 10) high-pressure nozzle systems 101 create mists, or atomized water, by forcing water through a small orifice under high pressures onto a patterned surface. Nozzle design is a very mature art and many types of design and effects of atomization can be achieved depending on the pressure and geometry of the nozzle. The fluid needs to have a significant pressure in order for the nozzle to create fluid droplets. A pump 103 can be employed to impart on the fluid to the nozzle with sufficient pressure The effect is most pronounced when the spray 104 impinges on the surface at an upward angle The upward velocity of the spray helps to mitigate the affect of gravity on the thick film of fluid in the regions of favorable interaction. By selecting high-pressure water line, or high-pressure pump and appropriate nozzle design, it is possible to produce a spray the patterned surface with any droplet size and pattern. The dimensions of the pattern surface and the spray pattern produced by the nozzle will dictate the number of nozzles necessary to fully cover the surface with fluid. Lighting 106 is optionally employed to ensure that that viewer can best see the contrast. After impinging on the patterned surface 105 the fluid passively flows back down into the fluid reservoir 107.

In another embodiment running water directed to flow over the patterned surface. The surface energy provides a small force that can direct the path of the flowing water. If the kinetic energy of the flowing water of the flowing water is comparable to the surface energy force then the path of the water can be preferentially controlled to produce the patterned image. The kinetic energy of the water depends on the volume and velocity of water flowing over the surface. In this case the actual flow of water along the surface, rather than a droplet or spray, is used to display the surface pattern.

The visual display can be enhanced with lighting situated to reflect from or diffract through the liquid droplets. Thin fluid films are generally transparent and do not reflect light back toward the viewer whereas thick films will reflect light. Small droplets reflect and refract light efficiently because the incident light contacts the curved droplet surface at a plurality of angles. Large droplets and thick films produce a different appearance which may be enhance by the curvature of the patterned surface

Bright lighting positioned above or below the patterned surface enhances the contrast with areas covered by a film of liquid. If the patterned surface is glass the regions with a thin film of liquid will be transparent and the viewer will see through the object. A dark background behind the patterned surface will produce a bright area where light is reflected from the droplets and a dark background where light is transmitted through the thin film. The contrast provided by lightening is maximized when light is reflected or refracted from liquid on the surface and minimal light is reflected or refracted through the material surface.

Those skilled in the art of lighting design can create a multitude of different means of achieving lighting effects that will illuminate and enhance the patterned surface through reflection of light by the liquid, background, and substrate material. Colors, colored lighting, fluorescence liquids, backlights, and other attractive lighting configurations can all be used under the same basic principles to make the liquid patterned surface appear, or highlight this image, design, or alphanumeric message on the surface. Alterations in the surface including but not limited to frosted glass and etched patterns can also be used to vary the appearance of the patterned surface.

The present invention also provides for processes for producing articles with patterned glass surfaces useful for signs, logos, patterns or visual displays. These processes utilize well known techniques (e.g., pad printing, contact printing, screen printing, ink jet printing) to print masks onto a surface to block modification of a portion of the surface. A mask is an object or temporary surface coating or covering that prevents treatment of selected regions of the surface while unmasked regions of the surface are exposed to a chemical or physical treatment. After the treatment is completed the mask is removed to expose an unmodified surface. Alternatively the printing techniques can be adapted to directly print a SAM onto a surface.

In an embodiment of the present invention there is provided a process for producing patterned surfaces for signs and visual displays comprising application of a masking substance that is soluble in water and insoluble in organic solvents. When the surface treated is an inorganic oxide surface the mask will cover hydrophilic regions of the surface. The entire surface is exposed to the molecular species under conditions which produce a covalent attachment with the first end of the molecular species. The unmasked surface is chemically modified to produce a hydrophobic surface. When the processing is complete the mask can be removed by washing the surface with water to remove the ink mask.

### EXAMPLE 1

### Direct Printing onto a Material Surface

A water-soluble mask is applied to an inorganic oxide surface. The masking species is selected to be insoluble in and inert and impervious to a solution of the molecular species used to pattern the surface dissolved in toluene or alternate organic solution. Furthermore the ink must be easily removed from the patterned surface with altering the SAM. Such masking substances are well known in the art. Black water-soluble Speedball ink or Crayola water-based paints can be used successfully for the present process although one skilled in the art will recognize other equivalent masking agents. The masked surface is exposed to a solution of about 0.5-0.01 mol % solution of octadecyltrichlorosilane in toluene at room temperature for 15 minutes (S. R. Wasserman el al. “Structure and Reactivity of Alkyltrichlorosiloxanes on Silicon Substrates, Langmuir 1989 5:1074, J. V. Davidovitis et al. Temperature Influence on the Formation of Silanized Monolayers on Silica: an Atomic Force Microscopy Study” Surface Sci. 1996 352-354:369-73:; K. Mathauer and C. Frank “Binary Self-Assembled Monolayers as Prepared by Successive Adsorption of Alkyltrichlorosiloxanes”, Langmuir 1993 9 3446) Other inert hydrocarbon, halocarbon or aromatic solvents can be substituted for toluene The duration of exposure necessary is effected by the SAM concentration in solution, temperature and water content of the solution and surface. Alternatively the surface coating may be applied by chemical vapor deposition. After the unmasked surface is uniformly covered by the SAM the entire surface is rinsed with water or other solvent to remove the mask and expose the unmodified surface beneath the mask. If the surface is glass the area under the mask will be a hydrophilic inorganic oxide surface. Objects produced by the present techniques can be further treated with other surface-modifying agents to produce still more complex surface patterns.

In another embodiment of the invention there is provided a process for producing patterned surfaces for signs and visual displays comprising initially treating the entire surface with a molecular species adapted at a first end of the molecule with a functional group which can bind to the inorganic oxide surface and at a second end with a hydrocarbon or halocarbon chain cable of forming a hydrophobic SAM. The entire surface is modified to produce a hydrophobic surface. A mask is applied to the treated surface covering all areas in which the hydrophobic SAM is to be preserved and the object is exposed to ozone and UV light resulting in the chemical degradation of the unmasked SAM which regenerates a hydrophilic surface on the unmasked region. The mask must effectively block the covered region of the surface from UV irradiation and must be easily applied and removed. The mask can be a chemical coating applied directly to the surface or a mechanical stencil which exposes a limited portion of the surface to UV irradiation.

### EXAMPLE 2

### UV/Ozone Treatment of a Material Surface

A clean glass surface is treated with a 0.5-0.01 mol % solution of octadecyltrichlorosilane in toluene at room temperature for 15 min which produces a hydrophobic glass surface. Conditions for formation of self-assembled monolayers on glass are well known in the art. This typically produces a hydrophobic surface which results in a contact angle of at least about 75°. While a single monolayer should provide the most hydrophobic surface, achieving a single monolayer requires precise experimental conditions and the contrast between liquids applied to thicker layers and untreated hydrophilic surfaces is readily observable. A mask comprised of a thin film (at least about 40 μm) of polydimethylsiloxane (PDMS) is then placed over surface regions where a hydrophobic surface is desired. The SAM-coated and masked surface is exposed to UV light and ozone (Jelight, Irvine Calif.) at a distance of about 20 cm from the light source. The UV/O₃ treatment degrades the exposed SAM regenerating the original hydrophilic surface in non-masked regions. The PDMS mask is removed from the surface

The contact printing techniques developed by Whitesides et al. provide another method to apply the SAM in specific regions. Screen printing, inkjet printing and pad printing are alternative techniques well known in the art for applying surface coatings, inks or paints top surfaces. Other techniques include direct application of the molecular species by contacting the surface with a sponge or elastomeric material containing the molecular species. These techniques could be used to modify large surfaces already in place.

Unlike inorganic oxide surfaces, plastic surfaces generally are hydrophobic. Hydrophobic plastic surfaces (e.g., polyethylene, polypropylene, polystyrene, polybutadiene, poly(methyl methacrylate, polytetrafluoroethylene, polydimethylsiloxane, etc.) can be converted to patterned surfaces by chemical modification of regions of the plastic surface to produce hydrophilic functionality on the surface of the plastic. Exposure of the masked plastic surface to UV/ozone oxidizes the exposed plastic surface to produce hydrophilic alcohol and carboxylic acids providing a hydrophilic surface.

All references cited in the application are hereby incorporated in their entirety into this specification. Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claim is reserved.

We claim:

1. A material surface said surface comprising hydrophobic or hydrophilic regions said regions producing differences in droplet size, shape, density, polydispersity and structure factor in a liquid contacting said regions disposed on said surface in a predefined pattern.

2. An article comprising a material surface patterned with hydrophobic or hydrophilic regions on said surface which when covered with a liquid produces differences in the droplet size, shape, density, polydispersity and structure factor of said liquid that creates a sign, logo, pattern, or visual display.

3. An article according to claim 2 wherein said material surface is a glass surface.

4. An article according to claim 2 wherein said material surface is an aluminum oxide surface.

5. An article according to claim 2 wherein said material surface is an zinc oxide surface.

6. An article according to claim 2 wherein said material surface is an chromium oxide surface.

7. An article according to claim 2 wherein said material surface is an nickel oxide surface.

8. An article according to claim 2 wherein said material surface is an titanium oxide surface.

9. An article according to claim 2 wherein said material surface is a polymer surface.

10. An article according to claim 9 wherein said polymer surface is a plastic surface.

11. An article according to claim 2 wherein said article is a liquid container, mug, pitcher, ice bucket, or cooler.

12. An article according to claim 2 wherein said article is a glass window or door.

13. An article according to claim 2 wherein said article is a car or truck window or door

14. An article according to claim 2 wherein said article is a label.

15. An article according to claim 2 wherein said article is a shower door.

16. An article according to claim 2 wherein said article is a water fountain or a water fall.

17. An article according to claim 2 wherein said article is a promotional device.

18. A method for producing a sign, logo, pattern, or visual displays comprising producing surface with hydrophobic and hydrophilic regions on said surface and applying a liquid to said surface such that said hydrophobic and hydrophilic regions produce visually distinct differences in the droplet size, density, polydispersity and structure factor of said liquid.

19. A method according to claim 18 wherein the hydrophilic and hydrophobic regions comprising the surface pattern are produced by chemical modification of an inorganic oxide or a plastic surface.

20. A method according to claim 18 wherein said hydrophobic surface comprises a self-assembled monolayers resulting from treating said inorganic oxide surface with a molecular species terminated in a first end in a functional group selected to bind to said patterned surface and terminated in a second end with a hydrocarbon or halocarbon chain capable of forming a self assembled monolayer.

21. A method according to claim 20 wherein said molecular species is selected from a group consisting of alkyltrichlorosilanes, haloalkyltrichlorosilanes, alkyltrialkoxy silanes or haloalkyltrialkoxysilanes.

22. A method according to claim 21 wherein said oxide surface is glass and said compound is octadecyltrichlorosilanes.

23. A method according to claim 18 wherein said surface is treated with a molecular species terminated in a first end in a functional group selected to bind to said patterned surface and terminated in a second end with a functional group which can be further modified to incorporate specific surface properties.

24. A method according to claim 20 where said surface is an inorganic oxide surface.

25. A method according to claim 20 where said surface is plastic

26. A method according to claim 20 wherein said inorganic oxide surface is silicon.

27. A method according to claim 24 wherein said inorganic oxide is a glass surface.

28. A method according to claim 20 wherein said inorganic oxide surface is aluminum oxide.

29. A method according to claim 20 wherein said inorganic oxide surface is zinc oxide.

30. A method according to claim 20 wherein said inorganic oxide surface is chromium oxide.

31. A method according to claim 20 wherein said inorganic oxide surface is nickel oxide.

32. A method according to claim 20 wherein said inorganic oxide surface is titanium oxide.

33. A method according to claim 20 wherein said liquid is applied by condensation of atmospheric humidity.

34. A method according to claim 20 wherein said liquid is applied by exhaling on said surface.

35. A method according to claim 20 wherein said liquid is applied by ultrasonic atomization.

36. A method according to claim 20 wherein said liquid is applied by centrifugal atomization

37. A method according to claim 20 wherein said liquid is applied by steam atomization.

38. A method according to claim 20 wherein said liquid is applied by spraying said surface with a stream from a high-pressure nozzle.

39. A method according to claim 20 wherein said liquid flows over said surface.

40. A method according to claim 20 wherein said surface is immersed in said liquid.

41. A method according to claim 20 wherein said sign, logo pattern or visual display is enhanced by addition of a light source that reflects light from or diffracts light though said liquid.

42. A process preparing sign, logo, pattern, or visual display from a patterned surface comprising chemical modification of some or all of said surface to produce hydrophobic and or hydrophilic regions on said surface

43. A process according to claim 42 said process comprising
(a) covering a portion of an inorganic oxide surface with a mask soluble in a polar solvent and insoluble in non-polar solvents capable of blocking exposure to or reaction with a molecular species;
(b) treating the surface with a solution of said molecular species in a nonpolar solvent said molecular species comprising a molecule terminating at one end in a functional group selected to bind to the inorganic oxide surface;
(c) washing unreacted portions of said molecular species off and drying said surface;
(d) washing off or removing said mask with a polar solvent to expose untreated inorganic oxide surface.

44. A process according to claim 42 wherein said molecular species is a compound selected from a group consisting of alkyltrichlorosilanes, haloalkyltrichlorosilanes, alkyltrialkoxysilanes or haloalkyltrialkoxysilane; said polar solvent is water and said nonpolar solvent is toluene.

45. A process according to claim 42 said process comprising:
(a) treating the inorganic oxide surface with a molecular species terminating at one end in a functional group selected to bind to the surface;
(b) covering portions of said surface with a mask capable of blocking exposure to or reaction with UV light or ozone;
(c) exposing the surface to UV/ozone to react with and remove said first molecular species and expose the original inorganic oxide surface;
(d) washing off or removing said mask to expose a treated surface.

46. A process according to claim 42 said process comprising contact printing a molecular species terminating at a first end in a functional group selected to bind to said patterned surface onto said surface.

47. A process according to claim 42 said process comprising stamp pad printing a molecular species terminating at a first end in a functional group selected to bind to said patterned surface.

48. A process according to claim 42 said process comprising: screen printing a molecular species terminating at a first end in a functional group selected to bind to said patterned surface.

49. A process for preparing a plastic patterned surface according to claim 42 said process comprising:
(a) covering a portion of said plastic surface with a mask capable of blocking exposure to UV light or reaction with a ozone.
(b) exposing said plastic surface to UV light and ozone;
(c) removing said mask
